(19) United States
(12) Patent Application Publication
(10) Pub. No.: US 2007/0127499 A1
(43) Pub. Date: Jun. 7, 2007

(54) Voice packet communication apparatus and method in wireless communication system

(75) Inventors: Dae-Seok Choi, Yongin-si (KR); Young-Jun Park, Seoul (KR); Kug Shin, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/633,781

(22) Filed: Dec. 5, 2006

(30) Foreign Application Priority Data
Dec. 5, 2005 (KR) 2005-117460

(51) Int. Cl. H04L 12/56

(52) U.S. Cl. 370/395.52

(57) ABSTRACT

A voice packet communication apparatus and method in a wireless communication system are provided. The communication method includes extracting, at a base station, RTP data from an IP packet received from a corresponding terminal in voice packet communication, generating the RTP data as a MAC PDU, and sending the generated MAC PDU to a wireless terminal; and extracting, at the wireless terminal, the RTP data from the MAC PDU received from the base station and reproducing the RTP data through a voice codec. Since the amount of data to be transmitted and received in the radio section is reduced, the present invention can enhance the bandwidth efficiency.

### PRIORITY

This application claims priority under 35 U.S.C. § 119 to an application filed in the Korean Intellectual Property Office on Dec. 5, 2005 and assigned Serial No. 2005-117460, the contents of which are incorporated herein by reference.

### BACKGROUND OF THE INVENTION

1. Field of the Invention

The present invention relates generally to a voice packet communication apparatus and method in a wireless communication system, and in particular, to an apparatus and method for communications in a radio section by removing an IP layer header of a Voice over IP (VoIP) packet.

2. Description of the Related Art

Voice over IP (VoIP) service, which delivers voice on packets in real time, has been invented to provide the existing telephone service over the packet-based IP data network. The call setup of VoIP is carried out according to a signaling protocol such as H.323 and Session Initiation Protocol (SIP). Through the signal protocol, a communication path is established and the characteristics of the voice data, to mutually exchange the data, is determined.

Upon the call setup, the voices of a sender and a recipient are sampled, carried on a Real Time Protocol (RTP), and then transmitted according to a User Datagram Protocol/Internet Protocol (UDP/ID). In general, when some packet loss happens during the delivery, it does not considerably affect the overall voice quality of voice packet communications. But, when the voice is not delivered in real time, quality degradation emerges right away. Accordingly, to ensure better voice quality, a system is designed to meet the real-time delivery characteristic, rather than to ensure the integrity of the voice data, in the voice delivery service such as VoIP.

However, in the related art, the voice packet communication sets a session for the voice data exchange using a signaling protocol such as H.323 and SIP, converts the sampled voice to a RTP packet, and carries the RTP packet on a payload of the UDP. A terminal receiving the packet reproduces the voice using a suitable codec based on the type of the RTP payload. As such, without discriminating the wired and wireless sections, the communication is achieved by applying the UDP/IIP to every VoIP packet.

When transmitting network/IP layer header information of the wired section in the radio section, the IP layer header (28 bytes) may act as overhead in the radio section. The bandwidth efficiency deteriorates in the radio section because of a great amount of data to transmit in the radio section. Additionally, it is disadvantageous in that latency increases until the terminal reproduces the received packet after passing the received packet through a network protocol stack.

### SUMMARY OF THE INVENTION

An aspect of the present invention is to substantially solve at least the above problems and/or disadvantages and to provide at least the advantages below. Accordingly, an aspect of the present invention is to provide an apparatus and method of efficiently utilizing a bandwidth in a radio section in the voice packet communication of a wireless communication system.

Another aspect of the present invention is to provide an apparatus and method of directly reproducing VoIP data at a terminal without passing the VoIP data through a network stack in a wireless communication system.

A further aspect of the present invention is to provide an apparatus and method for communications in a radio section by removing an IP layer header of a VoIP packet in a wireless communication system.

The above aspects are achieved by providing a communication apparatus of a base station in a wireless communication system, which includes a gateway module which extracts real time protocol (RTP) data from an Internet Protocol (IP) packet received from an IP network and provides the extracted RTP data to a wireless MAC layer part; and the wireless MAC layer part which generates a media access control (MAC) packet data unit (PDU) with the RTP data provided from the gateway module and provides the generated MAC PDU to a physical layer part to transmit to a wireless terminal.

According to one aspect of the present invention, a communication apparatus of a terminal in a wireless communication system includes a MAC layer part which provides RTP data to a voice codec when a MAC PDU received from a base station contains the RTP data, and provides an IP packet to an IP layer part when the received MAC PDU contains the IP packet; and the voice codec which reproduces the RTP data from the MAC layer part as an audible analog signal and outputs the audible analog signal to a speaker.

According to another aspect of the present invention, a communication method of a base station in a wireless communication system includes mapping a CID of a wireless terminal and an IP address of a corresponding terminal and recording the mapping relation to a database when setting up a voice packet call; extracting a RTP data from an IP packet received from the corresponding terminal; generating the RTP data as a MAC PDU by referring to the database; and sending the generated MAC PDU to the wireless terminal.

According to a further aspect of the present invention, a communication method of a terminal in a wireless communication system includes assigning a CID from a base station when setting up a voice packet call; generating RTP data which is generated at a voice codec during the call, as a MAC PDU using the assigned CID; and sending the generated MAC PDU to the base station.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates an overall procedure for voice packet communication in a wireless communication system according to the present invention;

FIG. 2 is a block diagram of a wireless terminal and a base station having a VoIP gateway according to the present invention;

FIG. 3 illustrates operations of the terminal in the wireless communication system according to the present invention; and

FIG. 4 illustrates operations of the base station in the wireless communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a solution for communications in a radio section by removing an IP layer header of a Voice over IP (VoIP) packet in a voice packet communication of a wireless communication system is described.

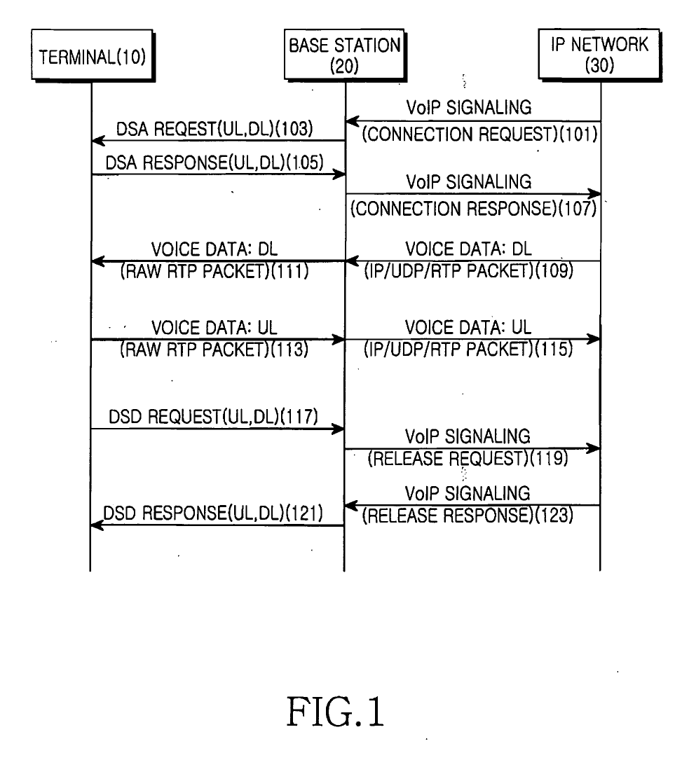

FIG. 1 illustrates an overall procedure for performing a voice packet communication in a wireless communication system according to the present invention. In the following, it is assumed that a wireless terminal receives a call.

As shown in FIG. 1, a base station 20 receives from an IP network 30 a signaling to request a VoIP call connection at step 101. Upon receiving the signaling which requests the VoIP call connection, the base station 20 sends a Dynamic Service Add (DSA) request message to a terminal 10 to establish the connection in the radio section at step 103. The DSA request message contains Connection ID (CID) information to establish the connection, information of a corresponding terminal requesting the call, characteristic information of the voice data, and so forth. That is, the terminal 10 sets parameters of a voice reproducing module (voice codec) based on the information acquired from the DSA request message.

Next, at step 105, the base station 20 receives a DSA response message from the terminal 10 in reply to the DSA request message. The terminal 10 is assigned different CIDs from the base station 20 to discriminate uplink and downlink radio links. After establishing the connection in the radio section, the base station 20 sets a session for the voice packet transmission and reception by sending to the IP network 30 a response message which indicates the acceptance of the VoIP call connection at step 107.

After setting the session, the base station 20 receives a voice packet (a VoIP packet) of a caller from the IP network 30 at step 109. The voice packet received over the IP network 30 is a UDP/IP packet. Upon receiving the voice packet of the caller, the base station 20 removes a UDP/IP layer header from the received voice packet and sends it to the terminal 10 by mapping the header-free RTP packet to the downlink CID at step 111. In other words, the base station 20 generates a Medium Access Control (MAC) Packet Data Unit (PDU) using the RTP packet and sends the RTP packet to the terminal 10. Since the voice data carried on the received MAC PDU is the RTP packet, the terminal 10 forwards the RTP packet directly to the voice reproducing module (voice codec) and reproduces the RTP packet as an audible voice signal, without providing the received voice data to the IP layer.

At step 113, the terminal 10 generates voice input through a microphone as an RTP packet and sends the RTP packet to the base station 20 by mapping it to the uplink CID. The base station 20 generates the RTP packet received from the terminal 10 as a UDP/IP packet using the corresponding IP address acquired in the call establishment and sends the UDP/IP packet to the IP network 30 at step 115. The UDP/IP packet is generated from the RTP packet from the terminal 10 and then transmitted to the caller.

During the voice packet communication, when call termination is selected by a user of the terminal 10, the terminal 10 sends to the base station 20 a Dynamic Service Deletion (DSD) request message which requests the call termination at step 117. At step 119, the base station 20 sends to the IP network 30 a VoIP signaling message which requests the call release.

The base station 20 receives a response message which informs the base station 20 of the acceptance of the call release from the IP network 30 at step 123, and releases the VoIP session by sending a DSD response message to the terminal 10 at step 121.

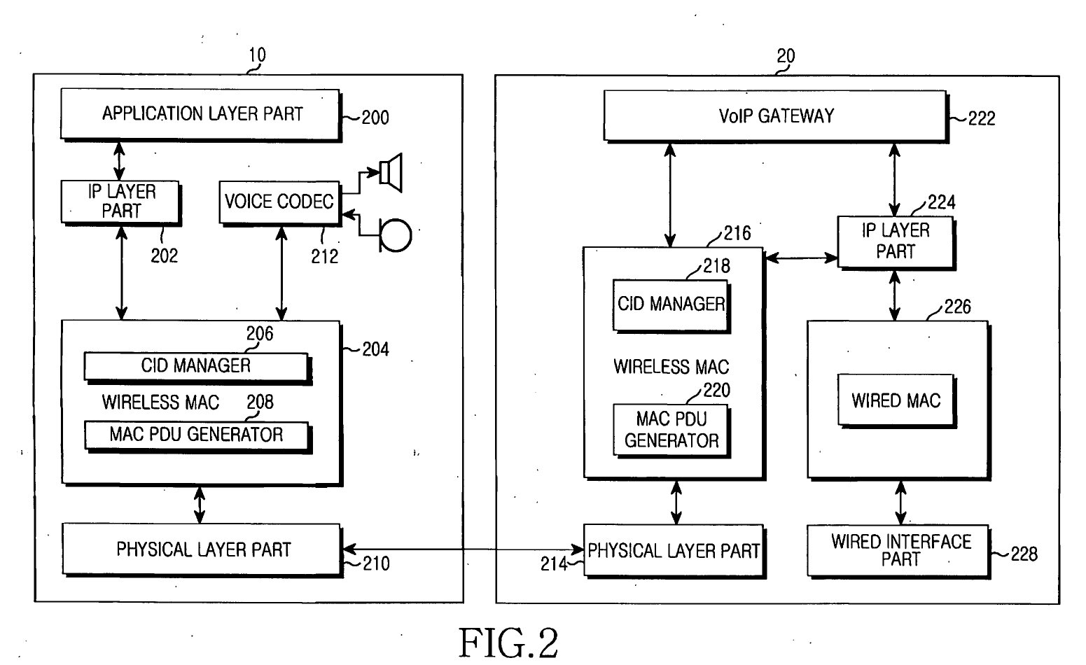

FIG. 2 is a block diagram of a wireless terminal and a base station having a VoIP gateway according to the present invention.

As shown in FIG. 2, the terminal 10 includes an application layer part 200, an IP layer part 202, a MAC layer part 204, a physical layer part 210, and a voice codec 212. The MAC layer part 204 includes a CID manager 206 and a MAC PDU generator 208. The base station 20 includes a physical layer part 214, a wireless MAC layer part 216, a VoIP gateway 222, an IP layer part 224, a wired MAC layer part 226, and a wired interface part 228. The wireless MAC layer part 216 includes a CID manager 218 and a MAC PDU generator 220.

In the terminal 10, the application layer part 200 provides a user with various application services (e.g., electronic mail, FTP, etc) for performing communications. The IP layer part 202 generates data from the application layer part 200 as a UDP/IP packet and transfers the generated UDP/IP packet to the MAC layer part 204. The IP layer part 202 extracts application service data from the IP packet of the MAC layer part 204 and transfers the extracted data to the application layer part 200.

The voice codec 212 generates voice input from the microphone as an RTP packet and sends the RTP packet to the MAC layer part 204. The voice codec 212 converts the RTP packet from the MAC layer part 204 to an analog signal and then outputs the analog signal to a speaker.

The MAC layer part 204 generates the packet from the IP layer part 202 or the voice codec 212 as a MAC PDU and provides the MAC PDU to the physical layer part 210. Conversely, the MAC layer part 204 interprets the MAC PDU from the physical layer part 210. When data in the payload is an IP packet, the MAC layer part 204 provides the IP packet to the IP layer part 202. When the data is an RTP packet, the RTP packet is provided to the voice codec 212.

The CID manager 206 in the MAC layer part 204 manages uplink and downlink CIDs allocated from the base station. The CID manager 206 can manage a pair of CIDs (uplink and downlink CIDs) for each service. The MAC PDU generator 208 in the MAC layer part 204, when receiving a packet from the IP layer part 202 or the voice codec 212, acquires from the CID manager 206 a CID corresponding to the packet, generates a MAC PDU using the acquired CID, and sends the MAC PDU to the physical layer part 210. The MAC PDU generator 208 also acquires a CID by analyzing the header of the MAC PDU provided from the physical layer part 210, discriminates the service using the acquired CID, and provides the received packet to the IP layer part 202 or the voice codec 212.

The physical layer part 210 demodulates a signal received in the radio channel and provides the original information data to the MAC layer part 204. The physical layer part 210 modulates information data from the MAC layer part 204 to an actual transmittable form and sends it in the radio channel.

In the base station 20, the physical layer part 214 demodulates a signal received in the radio channel and provides the original information data to the wireless MAC layer part 216. The physical layer part 214 modulates information data from the wireless MAC layer part 216 to an actual transmittable form and sends it in the radio channel.

The wireless MAC layer part 216 generates a packet from the VoIP gateway 222 or the IP layer part 224 as a MAC PDU and provides the MAC PDU to the physical layer part 214. The wireless MAC layer part 216 also analyses a MAC PDU from the physical layer part 214. When data of the payload is an IP packet, the wireless MAC layer part 216 provides the IP packet to the IP layer part 224. When the data is an RTP packet, the RTP packet and the destination IP address of the RTP packet are provided to the VoIP gateway 222.

The CID manager 218 of the wireless MAC layer part 216 manages the mapping relation between the CID allocated to the terminal and the corresponding IP address for each service. The MAC PDU generator 220 in the wireless MAC layer part 216, when receiving a packet from the IP layer part 224 or the VoIP gateway 222, acquires an CID corresponding to the packet from the CID manager 218, generates a MAC PDU using the acquired CID, and provides the MAC PDU to the physical layer 214. The MAC PDU generator 220 also acquires an CID by analyzing a header of the MAC PDU provided from the physical layer part 214, discriminates the service using the acquired CID, and provides the received packet to the IP layer part 224 or the VoIP gateway 222.

The VoIP gateway 222 manages the IP layer header information (IP address and so forth) acquired when setting the VoIP call. Also, the VoIP gateway 222 extracts the voice data (the RTP packet) from the VoIP packet of the IP layer part 224 and provides the extracted voice data to the wireless MAC layer part 216. The VoIP gateway 222 also generates the voice data (the RTP packet) from the wireless MAC layer part 216 as an IP packet using the already known IP layer header information and provides the generated IP packet to the IP layer part 224.

The IP layer part 224 forwards the VoIP packet from the VoIP gateway 224 or the wireless MAC layer part 216 to the wired MAC layer part 226. After analyzing an IP packet from the wired MAC layer part 226, the IP layer part 224 forwards the IP packet to the VoIP gateway 222 when the IP packet is a voice packet. Otherwise, the IP layer part 224 forwards the IP packet to the wireless MAC layer part216.

The wired MAC layer part 226 generates the UDP/IP packet from the IP layer part 225 as a wired MAC layer data unit and provides the wired MAC layer data unit to the wired interface part 228. The wired MAC layer part 226 extracts the IP packet from the data unit of the wired interface part 228 and provides the extracted IP packet to the IP layer part 224.

The wired interface part 228 demodulates a signal received through a cable (not shown) and provides the original information data to the wired MAC layer part 226. The wired interface part 228 modulates information data from the wired MAC layer part 226 to an actual transmittable form and sends it through the cable.

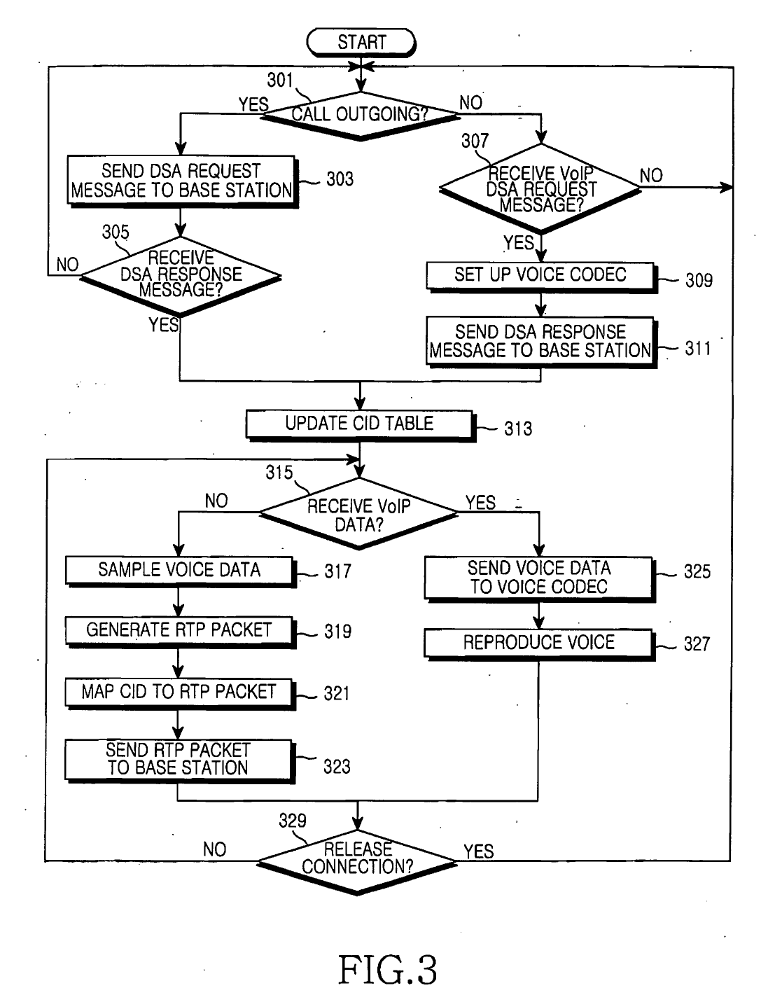

FIG. 3 illustrates operations of the terminal 10 in the wireless communication system according to the present invention.

Referring to FIG. 3, the terminal 10 determines if the user sends a call at step 301. When the outgoing call is detected, the terminal 10 generates and sends a DSA request message, which requests the call setup, to the base station at step 303. The DSA request message contains the codec information of the terminal 10, the IP address, the information of the corresponding terminal and so forth.

After transmitting the DSA request message, the terminal 10 determines if a DSA response message is received at step 305. Not receiving the DSA response message, the terminal 10 determines the call is rejected and returns to step 301. When receiving the DSA response message, after setting up the voice codec based on the information contained in the DSA response message, the terminal 10 updates an CID table on the basis of the CID information contained in the DSA response message at step 313.

After updating the CID table, the terminal 10 determines if the VoIP data is received at step 315. To transmit the user's voice, the terminal 10 samples the user's voice input through the microphone at step 317 and generates an RTP packet using the sampled voice data at step 319. The terminal 10 maps the corresponding CID to the RTP packet based on the CID table at step 321, transmits the CID-mapped RTP packet to the base station at step 323, and proceeds to step 329. In short, the CID is recorded in the header, and the MAC PDU carrying the RTP packet on the payload is generated and transmitted to the base station.

When receiving the VoIP data, the terminal 10 provides the received voice data directly to the voice codec, without passing through the IP layer, at step 325, reproduces the received voice data through the voice codec at step 327, and proceeds to step 329.

At step 329, the terminal 10 determines if the call connection is released by the user's key action or the corresponding terminal. If the call connection is released, the terminal 10 returns to step 301 and resumes the subsequent steps. If the call connection is not released, the terminal 10 returns to step 315 and resumes the subsequent steps to continue the calling.

When the outgoing call is not detected at step 301, the terminal 10 determines if a DSA request message requesting the VoIP call setup is received from the base station at step 307. If the DSA request message is not received, the terminal 10 returns to step 301 and resumes the subsequent steps. If the DSA request message is received, the terminal 10 sets up the voice codec based on the information contained in the DSA request message at step 309. The terminal sends a DSA response message to the base station in reply to the DSA request message at step 311 and proceeds to step 313.

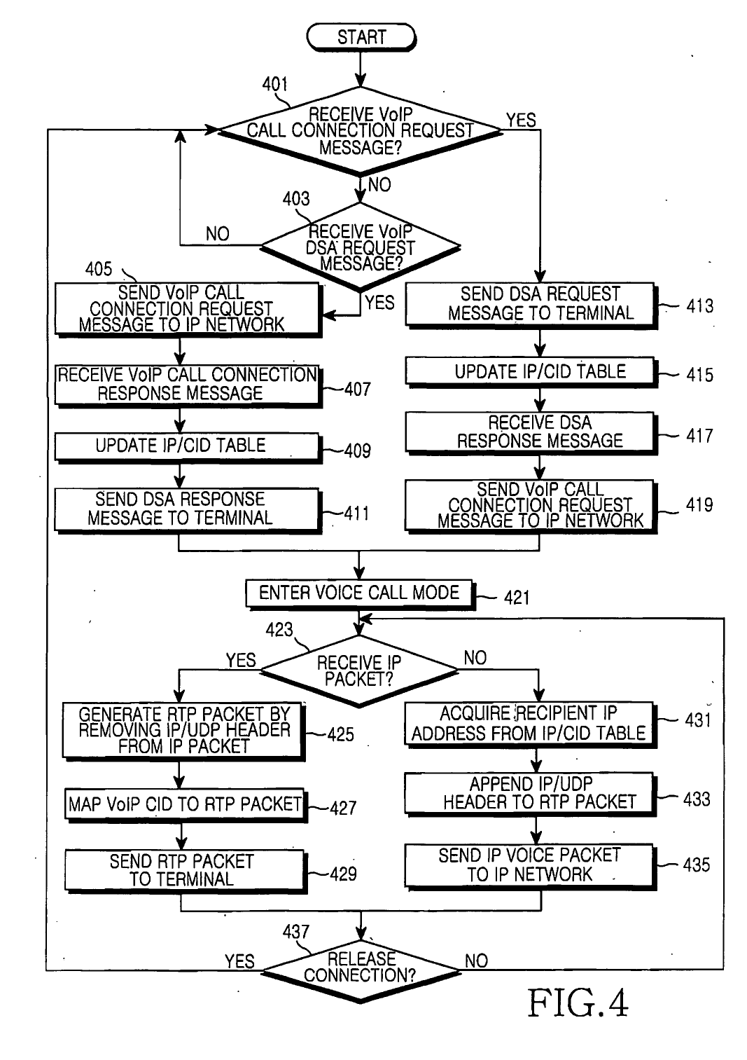

FIG. 4 illustrates operations of the base station 20 in the wireless communication system according to the present invention.

Referring to FIG. 4, the base station 20 determines if a VoIP call connection request message is received from the IP network at step 401. The VoIP call connection request message is a signaling message such as H.323 and SIP.

When not receiving the VoIP call connection request message, the base station 20 determines if a DSA request message, which requests the VoIP call setup, is received from the terminal at step 403. Not receiving the DSA request message, the base station 20 returns to step 401. When the DSA request message is received, the base station 20 sends a VoIP call connection request message to the IP network (or the callee) at step 405.

The base station 20 receives a VoIP call connection response message from the IP network in reply to the VoIP call connection request message at step 407. At step 409, the base station 20 updates the CID table by mapping the IP address of the callee acquired in the call setup process and the CID assigned to the corresponding wireless terminal. The base station 20 sends to the terminal a DSA response message including the CID assigned to the terminal at step 411 and enters the voice call mode at step 421.

Upon entering the voice call mode, the base station 20 determines if an IP packet containing the voice data is received from the IP network at step 423. Receiving the IP packet, the base station generates an RTP packet by removing the IP/UDP layer header from the received IP packet at step 425. The base station 20 maps the corresponding CID to the RTP packet based on the CID table at step 427, sends the CID-mapped RTP packet to the terminal at step 429, and then proceeds to step 437.

After entering the voice call mode, when the RTP packet is received from the terminal, the base station 20 accesses the CID table with the CID mapped to the RTP packet and acquires the IP address of the external Internet terminal at step 431. The base station 20 generates an IP packet by appending the IP/UDP layer header to the received RTP packet at step 433, sends the IP packet to the IP network (or the external Internet terminal) at step 435, and then proceeds to step 437.

At step 437, the base station 20 determines if the call connection is released by the caller or the callee. If the call connection is released, the base station 20 returns to step 401 to resume the subsequent steps. If the call connection is not released, the base station 10 returns to step 423 to resume the subsequent steps to continue the call.

When the VoIP call connection request message is received at step 401, the base station 20 sends to the corresponding terminal a DSA request message including the CID to be used for the voice packet communication at step 413. At step 415, the base station 20 updates the CID table by mapping the CID assigned to the terminal and the caller IP address. The base station 20 receives from the terminal at step 417 a DSA response message, which informs the acceptance of the call connection. Upon receiving the DSA response message, the base station 20 sends a VoIP call connection response message to the IP network (or the caller) in reply to the VoIP call connection request message at step 419 and proceeds to step 421.

As set forth above, since the present invention carries out the communication using the RTP packet in the radio section after removing the UDP/IP layer header therefrom, it is possible to reduce 28 bytes (IP 20 bytes and UDP 8 bytes) per voice data packet. Since the data amount to be transmitted and received in the radio section is reduced, the bandwidth efficiency can be enhanced. Additionally, the terminal provides the VoIP data directly to the voice reproducing module without passing through the network stack (the IP stack), to thereby reduce the delay due to the network stack. As a result, it is possible to satisfy the real-time characteristics in relation to the voice packet.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A communication apparatus of a base station in a wireless communication system, comprising:
a gateway module for extracting real time protocol (RTP) data from an Internet protocol (IP) packet received from an IP network and providing the extracted RTP data to a wireless MAC layer part; and
the wireless MAC layer part for generating a media access control (MAC) packet data unit (PDU) with the RTP data provided from the gateway module and providing the generated MAC PDU to a physical layer part to transmit to a wireless terminal.

2. The communication apparatus of claim 1, further comprising:
an IP layer part for providing the received IP packet to the gateway module when the IP packet received from the IP network contains RTP data, and providing the IP packet to the wireless MAC layer part when the received IP packet does not contain the RTP data.

3. The communication apparatus of claim 1, wherein the wireless MAC layer part provides RTP data to the gateway module when the MAC PDU received from the wireless terminal contains the RTP data, and
the gateway module generates the RTP data from the wireless MAC layer part as an IP packet using IP header information acquired in call setup and provides the generated IP packet to a wired MAC layer part to transmit to the IP network.

4. The communication apparatus of claim 1, wherein the wireless MAC layer part includes a database for storing mapping relation between a connection identifier (CID) for each service and a corresponding terminal IP address.

5. The communication apparatus of claim 4, wherein the wireless MAC layer part acquires a CID from a header of the MAC PDU received from the wireless terminal and discriminates a type of data contained in the MAC PDU by accessing the database with the CID.

6. A communication apparatus of a terminal in a wireless communication system, comprising:
a MAC layer part for providing RTP data to a voice codec when a MAC PDU received from a base station contains RTP data, and providing an IP packet to an IP layer part when the received MAC PDU contains an IP packet; and
the voice codec for reproducing the RTP data from the MAC layer part as an audible analog signal and outputs the audible analog signal to a speaker.

7. The communication apparatus of claim 6, wherein the MAC layer part includes a database for storing a CID for each service.

8. The communication apparatus of claim 7, wherein the MAC layer part acquires an CID from a header of the MAC PDU received from the base station, accesses the database with the CID, and discriminates a type of data contained in the MAC PDU.

9. The communication apparatus of claim 6, wherein the MAC layer part generates a MAC PDU with the RTP data from the voice codec and provides the generated MAC PDU to a physical layer part to transmit to the base station.

10. A communication method of a base station in a wireless communication system, comprising:
mapping a connection identifier (CID) of a wireless terminal and an IP address of a corresponding terminal and storing the mapping relation in a database when setting up a voice packet call;
extracting a real time protocol (RTP) data from an Internet Protocol (IP) packet received from the corresponding terminal;
generating the RTP data as a media access control (MAC) packet data unit (PDU) using the mapping relation stored in the database; and
sending the generated MAC PDU to the wireless terminal.

11. The communication method of claim 10, further comprising:
extracting RTP data from the MAC PDU received from the wireless terminal;
acquiring an IP address of the corresponding terminal by accessing the mapping relation stored in the database; and
generating the RTP data as an IP packet using the acquired IP address and sending the generated IP packet to the corresponding terminal.

12. The communication method of claim 10, wherein the voice packet call setup is conducted in conformity with H.323 or session initiation protocol (SIP).

13. A communication method of a terminal in a wireless communication system, comprising:
assigning a connection identifier (CID) from a base station when setting up a voice packet call;
generating real time protocol (RTP) data which is generated at a voice codec during the call, as a media access control (MAC) packet data unit (PDU) using the assigned CID; and
sending the generated MAC PDU to the base station.

14. The communication method of claim 13, further comprising:
extracting RTP data from a MAC PDU received from the base station; and
reproducing the extracted RTP data at the voice codec.

15. The communication method of claim 13, wherein the voice packet call setup is conducted in conformity with H.323 or session initiation protocol (SIP).

16. A voice packet communication method in a wireless communication system, comprising:
extracting, at a base station, real time protocol (RTP) data from an Internet Protocol (IP) packet received from a corresponding terminal in voice packet communication, generating the RTP data as a media access control (MAC) packet data unit (PDU), and sending the generated MAC PDU to a wireless terminal; and
extracting, at the wireless terminal, the RTP data from the MAC PDU received from the base station and reproducing the RTP data through a voice codec.

17. The voice packet communication method of claim 16, further comprising:
generating, at the wireless terminal, the RTP data generated at the voice codec as a MAC PDU and sending the generated MAC PDU to the base station; and
extracting, at the base station, the RTP data from the MAC PDU received from the wireless terminal, generating the RTP data as an IP packet using IP header information acquired in call setup, and sending the generated IP packet to the corresponding terminal.

18. The voice packet communication method of claim 16, wherein the voice packet call setup is conducted in conformity to H.323 or session initiation protocol (SIP).

19. A communication method of a base station in a wireless communication system, comprising:
generating a mapping relation between a connection identifier (CID) of a wireless terminal and an IP address of the terminal;
generating a media access control (MAC) packet data unit (PDU) using the mapping relation from a real time protocol (RTP) generated during the call.

20. A communication method of a terminal in a wireless communication system, comprising:
assigning a connection identifier (CID) from a base station when setting up a voice packet call; and
generating a media access control (MAC) packet data unit (PDU) using the assigned CID.
